(19) United States
(12) Patent Application Publication
(10) Pub. No.: US 2019/0105686 A1
(43) Pub. Date: Apr. 11, 2019

(54) Process for the polymer coating of non-ferrous metal surfaces

(71) Applicant: Héctor Delgado Morales, Xalatlaco (MX)

(72) Inventor: Héctor Delgado Morales, Xalatlaco (MX)

(21) Appl. No.: 15/726,147

(22) Filed: Oct. 5, 2017

(51) Int. Cl. B05D 7/14; B05D 7/00; B05D 3/02; B05D 3/10; B32B 5/18; B32B 5/30; B32B 7/12; B32B 27/32

(52) U.S. Cl. CPC B05D 7/14; B32B 2255/26; B05D 3/0218; B05D 3/102; B32B 5/18; B32B 5/30; B32B 7/12; B32B 27/32; B05D 2401/32; B05D 2451/00; B05D 2507/01; B05D 2507/02; B05D 2202/25; B05D 2202/45; B05D 7/52

(57) ABSTRACT

A process for coating a surface of a nonferrous metallic article with a bi-layer polymeric coating, said method comprising: 1) Subjecting the surface of a nonferrous metal article to a chemical washing; 2) Heating the article whose surface will be coated, to a temperature higher than the melting temperature of the selected polymer and lower than the ignition temperature thereof; 3) Apply the first coating layer, with a polymer size of particle of less than or equal to 20 mesh, keeping constant the substrate temperature; 4) Applying a second coating layer of plastic on the first coating layer, after the first layer has adhered to the substrate surface, where the second layer can be the same or different polymer, with a particle size equal to or less than 20 mesh; 5) Heating further the ensemble of substrate and bi-layer coating to a temperature higher than the selected at step 2, but lower than the ignition temperature of the coating and, 6) Cooling the thus coated substrate to room temperature. The product obtained offers a smooth, nonporous surface, high adhesion of the coating to the substrate and it is ensured the covering of all the surface exposed to the chemical treatment of the first stage, so that the resulting coated substrate is suitable for use in the food industry.

### BACKGROUND

This invention relates to a process for applying polymer coatings on non-ferrous metal surfaces, comprising two layers of coating, wherein the first layer offers a superior bond with the non-ferrous metal surface and the second layer allows a wide variety of surface finish.

It is well-known in the art of applying a plastic coating to a substrate, the use of methods such as dipping powder, fluidized bed and heat-shrinkable film. The main disadvantages with these methods are related to difficulty of operating with very different sizes and shapes of the articles to be coated and a very poor adhesion between the plastic coating and the surface of products made of non-ferrous metal.

There are numerous attempts aimed to new methods for applying coatings. For example, U.S. Pat. No. 2,983,704 (Roedel, 1961) discloses a process to polymerize ethylene to high density polymers with a high degree of linearity, crystallinity, and high density, as well as to produce blends of ethylene polymers.

U.S. Pat. No. 3,348,995 (Baker, et. al., 1967) discloses a method of coating metal surfaces with polyethylene, using a polyethylene primer; the method used to coat the metal surface is a process of two layers with the first layer being of high density polyethylene and the second layer of medium or low density polyethylene, or a mixture of both; the adhesion of the polyethylene to metal is improved by using a thin high density polyethylene primer coat, and the subsequent application to the hot metal of a lower density polyethylene layer of greater thickness; the temperature of the primer coat must be sufficient to melt the top coat.

U.S. Pat. No. 3,410,709 (Meyer, et al., 1968) discloses a method for a polymer coating on a metal, in which an organic crosslinking agent is mixed with powdered polyethylene and then this mixture is used to improve bonding to the metal surface, heating the polyethylene during the contacting to the surface to be coated, to sinter the polyethylene and form a coating over the article; following the sintering, the coated article is subjected to a further heat treatment, where cross-linking is effected and polyethylene is transformed into an infusible coating.

U.S. Pat. No. 3,639,189 (Hartman, 1972) discloses adhesive compositions comprising polyethylene and oxidized polyethylene, these blends having excellent adhesion to various substrates, particularly to metals, and can be applied directly as an adhesive protective coating from the melt; blends may additionally comprise an elastomer as an additional component.

U.S. Pat. No. 4,007,298 (Feehan, et. al., 1977) relates to polyethylene coatings for ferrous metals; this invention discloses a coating for ferrous metal surfaces comprising a blend of high density and low density polyethylene powder; the coating is completed to the desired thickness in one application of the blended powder on a hot ferrous metal surface, to take advantage of the binding properties of high density polyethylene and the flexibility and low cost of low density polyethylene.

U.S. Pat. No. 4,182,782 (Scheiber, 1980) describes a method for coating the outer surface of a metal pipe, wherein the process comprises coating a hot pipe with powder plastic using a fluidized bed with a mixture of a gas and the particles.

U.S. Pat. No. 4,211,595 (Samour, 1980) and U.S. Pat. No. 4,213,486 (Samour, et. al., 1980) disclose a method of first coating a steel pipe with a corrosion protective coating such as epoxy resin or other adhesive coating and then extruding or co-extruding an outer layer of polyethylene or other plastic.

U.S. Pat. No. 4,307,133 (Haselier, 1981) refers to a method for applying a polymer coating to a metal surface, and the polymer powder suitable for the method; this invention describes the use of a powder mixture of unstabilized and stabilized polyolefin for coating a hot metal surface by directly applying the compositions to heated metallic objects to provide the protective coating.

U.S. Pat. No. 4,319,610 (Eckner, 1982) is directed to a process for coating metal tubes and the use of so coated tubes; this invention describes a process for coating metal tubes or pipes using specific pre-heating temperatures for the pipes and plastic melt indexes.

U.S. Pat. No. 4,865,882 (Okano, et. al., 1989) discloses a method for powder coating of metallic articles, where a mixture of modified polypropylene and very low density polyethylene is used as a primary coating having excellent heat resistance and elongation on the article.

U.S. Pat. No. 4,921,558 (Johnson, 1990) relates to the use of polyethylene as an additive for poly(arylen sulphide)/long carbon fibre laminates to prevent micro-cracking.

U.S. Pat. No. 5,262,241 (Huggins, 1993) describes a method to produce surface coated products, where the coatings comprise solutions of sulfur-containing metallic compounds and fluorocarbon polymers dissolved in mineral oil solvents and are applied to surfaces of substrates such as metallic surfaces; the steps of the method include an abrasive cleaning/surface disruption, a surface coating and post treatment, cleaning and preservation.

U.S. Pat. No. 5,750,252 (Danner, et. al., 1998) describes a multi-layer or dual-film coating, wherein the first film is an adhesive layer lo hold the second film as a protective coating to the metal surface; the first film may be either a mono-layer or dual-layer film of ethylene acrylic acid and carboxy-modified polyethylene to a metal substrate with a second layer extruded over the first and comprises a low density polyethylene.

However none of the efforts described above have been designed to solve the problem of coating a surface of non-ferrous metals with a uniform layer of plastic, wherein the adhesive strength of the plastic coating layer be so high that it is almost impossible to detach. In addition, there is a need for a plastic coating that will not break, split, tear or crack, that is one hundred per cent safe for contact with food. A further need exists for a non-slip plastic coating that has sufficient strength to not degrade on contact with the acid or water and also support temperatures up to 110° C. using a pure polyethylene topcoat. Higher temperatures are possible with the use of additives or by use of other plastic resins, unaltered in its structure. Finally, there is a further need for a plastic coating when applied to a sheet, produces a product completely flexible and that fits any environment.

### SUMMARY

In view of the shortcomings of the prior art, it is an object of the invention to provide a process for coating nonferrous metal surfaces of articles, which is of simple operation and highly efficient.

It is other object of this invention to provide a process to coat nonferrous metal surfaces with a plastic coating which possesses a very high adhesion to the nonferrous metal surface coated.

It is another object of this invention to provide a process for coating nonferrous metal surfaces, capable of being used on articles with a wide variety of sizes and shapes.

It is a further object of this invention to provide a plastic coating composition to be applied on non-ferrous metal surfaces, wherein the plastic coating layer possesses desirable mechanical properties such as breaking strength or slip resistance.

Still another object of the present invention is to provide a plastic coating composition to be applied on non-ferrous metallic surfaces, which is chemically stable as to be used in contact with food.

A still further object of the present invention is to provide a plastic coating which also support temperatures up to 110° C. using a pure polyethylene topcoat, or higher temperatures with the use of additives or by the use of other plastic resins, unaltered in its structure.

Finally, it is another object of the present invention to provide a plastic coating useful for application on a nonferrous metal sheet to produce a totally flexible surface-coated product.

The above described and other objects will be apparent in the view of the following detailed description and accompanying figures.

### BRIEF DESCRIPTION OF THE FIGURES

FIG. 1 is a schematic representation of the nonferrous metal substrate with the two layers of coating after the process of the invention.

FIG. 2 is an schematic flowchart of the process of the invention.

FIG. 3 is an schematic flowchart of the first coating step of the process of the invention.

FIG. 4 is an example of an article with a plastic coating applied all over the exposed surface, using the process of the invention.

### DETAILED DESCRIPTION OF THE INVENTION

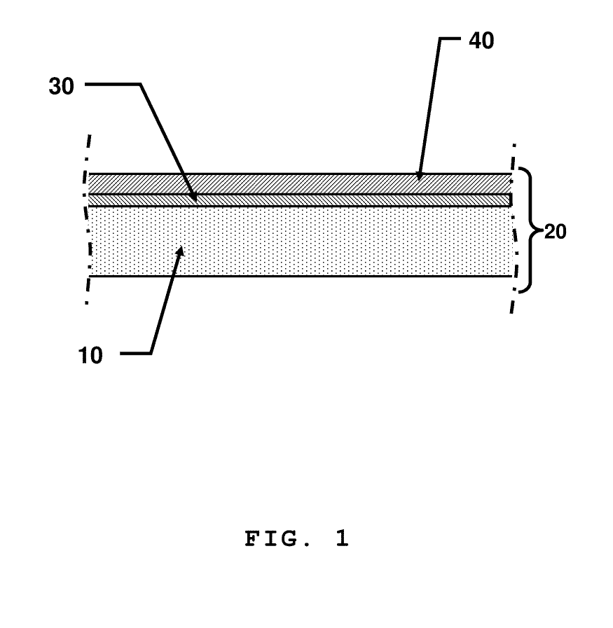

The invention relates to a process for coating the external surface of an article made of non-ferrous metals, with a polymeric material, in order to produce an article as shown in FIG. 1, where the non-ferrous substrate is referred as 10, and the coating comprises a polymeric bi-layer:
the first coating layer, 30, called the “adhesive layer”, produces a uniform covering with high adhesion to the substrate's surface under treatment, 10, and
the second coating layer, 40 called the “working layer”, is a polymeric material which is the same or different to that of the first layer 30,
the coated article is referred as 20.

The polymeric material used for the second coating layer, 40, is selected to provide a coating with desirable qualities, such as flexibility, tensile strength, anti-slip surface, as required for final use, and it can be tolerant to chemical attack from substances such as acids or other materials if the final use requires the article be in contact with food.

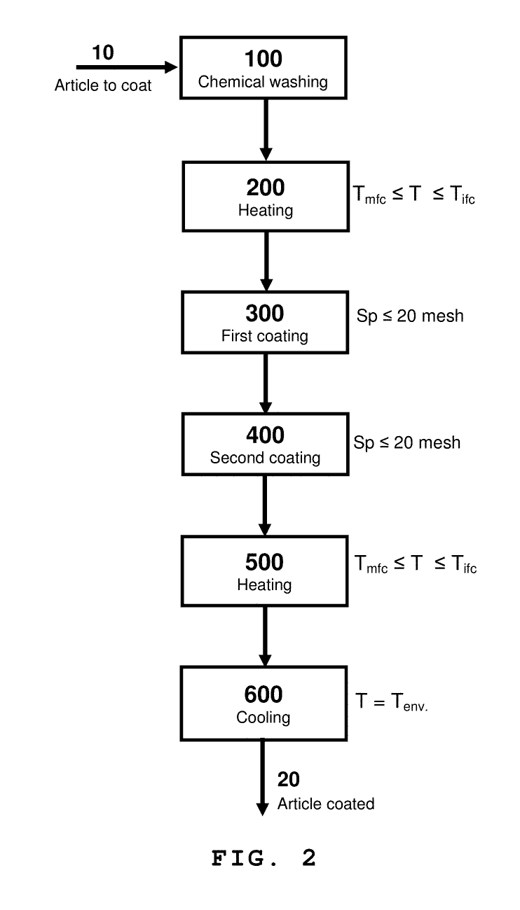

The procedure for coating of a nonferrous metal substrate of the invention is shown in the flowchart of FIG. 2, where a nonferrous metal object (10), is subjected to the successive steps of the process, as follows:

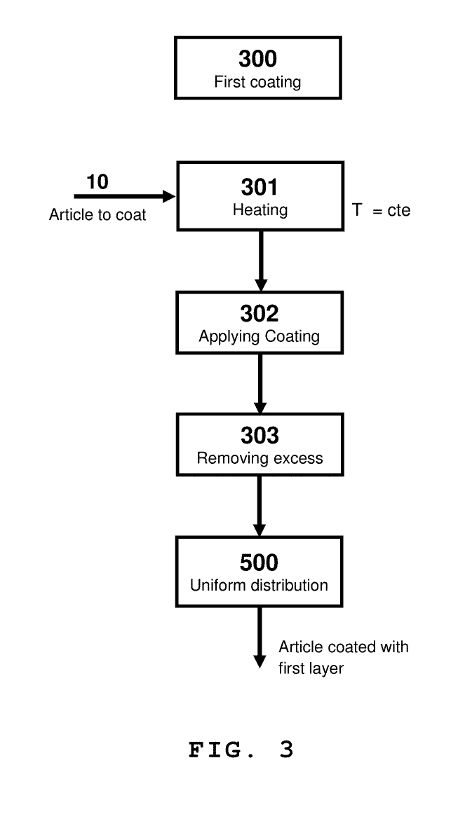

100. Treating the nonferrous metal surface of the object 10, by
101. chemically washing during a period of time as to observe that the metal “pore” is sufficiently open to receive the coating, and
102. washing the object with water to stop the corrosive effect of the chemical agent.
200. Heating the metal object (10) to a temperature above the melting temperature of the polymer selected for the first layer (T_{mfc}), but lower than the ignition temperature (T_{ifc}) thereof,
300. Applying a first coating layer of polymer, see FIG. 3,
301. maintaining the substrate temperature constant,
302. applying the first coating layer of polymer,
303. removing excess of the polymer, and
304. allowing the polymer to uniform distribute on the surface of the object until this first coating layer 30 has adhered to the surface of the article 10,
400. Applying a second layer of plastic coating, on the first coating layer 300 of the previous step,
500. Heating the ensemble of substrate and bi-layer coating up to a temperature between the melting temperature of the polymer selected for the first coating layer (T_{mfc}), but lower than the ignition temperature (T_{ifc}) thereof, to allow the polymer to flow over the surface and achieve a smooth surface finish, and
600. Cooling the coated substrate (20) to room temperature.

Non-ferrous substrates to which the method of the present invention as described above can be applied, are selected from the group of non-ferrous metals comprising: aluminium, copper and brass, aluminium alloy and copper, zinc, lead, silver and alloys; non-ferrous substrates particularly preferred in the present invention are those selected from the group comprising aluminium, copper and brass.

The first step, 100, of surface conditioning, consists of washing the object by immersion in an aqueous solution with a chemical agent/water ratio from 1:1 to 1:20, with an appropriate chemical agent selected from the group consisting of:
a) an acid solution from one or a mixture of acids such as phosphoric, acetic, muriatic, nitric, tannic and/or hydrochloric, or
b) a solution of caustic soda (sodium hydroxide) or other strong base.

The coating in the step 300 consist of a mixture of polymer powder and an appropriate conventional foaming agent with a particle size (Sp) of the polymer being less than or equal to 20 mesh.

The material of the second layer is a simple polymer such as polyethylene, polypropylene, nylon or any other compatible polymer or a mixture of different compatible polymers, such as polyethylene and polypropylene, or polyethylene and nylon, and it can be the same as in the step 300 or a different polymer, with a particle size (Sp) equal to, or less than 20 mesh.

To apply this first layer, 302 of FIG. 3, any conventional method can be used, such as spray or curtain coating, conventional rotomoulding techniques, powder dispersion coating; if the plastic material is mixed with a compatible solvent, it can be applied as a paste-like film. It is suggested that the temperature of the surface to be treated is around 400° C. to promote the formation of a thin coating layer.

The thickness of the film formed on the substrate, is based on a number of variables associated with the method used to apply the polymer. For example, when a spray or courting coating method is used, the thickness of the film can be controlled maintaining the substrate at a constant temperature and maintaining constant the flow in cascade of the plastic powder material over the said object for a certain time, while the object is rotated below the flow of the plastic material, thus occurs thickness of coating reasonably uniform.

While the first layer is still hot and melt, it is applied the second layer, formed by a plastic powder or ground material, using conventional techniques, including the application as extruded film. The second layer or working coating, can be any plastic material having a melt index in the range of 1 to 50 g/10 minutes, and the thickness of the film formed can be as high as 0.636 cm.

Polymers employed in the first and second layer of the covering can contain any conventional additive, that improve the physical properties thereof and change aesthetic characteristics of surface finish. Additionally, it is important that polymers that are used in accordance with the process described, have a particle size between 20 and 400 mesh, preferably 80 to 100 mesh (although in some applications, sizes in the range of 20 to 30 meshes are acceptable), because: a) this particle size allows the plastic material melt quickly and uniformly, b) several colours can be mixed so that its melt dispersion provide aesthetic finish, and c) the impact of the differences of the melting indexes is reduced, offering a softer plastic material.

The temperature of the non ferrous substrate to be covered, must be maintained constant during the steps of applying the first and second coating layers until all of the molten plastic material are uniformly distributed.

In alternative embodiments, the substrate may be:

i) preheated, if both sides of the object are going to be covered;

ii) heated only from the side that is not going to be covered; or

iii) in case the object to be covered possess sufficient thermal mass to completely melt the plastic, may be subject to preheat and apply two coats without reheating the object (if the temperature is sufficient to ensure the molten plastic material).

In case where the product to be coated is a sheet, heat must be applied to the opposite side to that which is being coated.

### Preferred Embodiment

In a preferred method of applying the process of the present invention, the polymeric material selected for both coating layers is polyethylene, which is ground to a particle size equal to, or less than 20 mesh, and has a density between 0.91 y 0.965 g/cm³, with a melt index of between 0.5 and 50 g/10 minutes. In particular, a preferred formulation for the first layer in a preferred embodiment of the present invention is a polyethylene with a density of between 0.937 and 0.939 g/cm³, with a melt index of 1 and 10 g/10 minutes.

For the second polymeric layer, it is preferred the use of polyethylene with low and high melting rates, that can be applied individually or mixed. A mix for the second layer in a preferred embodiment comprises a polyethylene with a melting index of 3 to 5 g/10 minutes and a polyethylene with a melting index of 20 to 30 g/10 minutes; this mixture allows to obtain different grains or grain coloured plastic in the coating, which adds values to the product by allowing colourful finish. Alternatively, the second layer consists of polyethylene with a melting index of 20 to 30 g/10 minutes, that provides some desirable surface features such as a smoother surface and more consistent colour.

Some examples of the application of the process of the invention, are as follows.

### EXAMPLE 1

The surface of an object made of aluminium is subjected to conditioning by chemical attack using a hydrochloric acid solution in water.

For both coating steps, polyethylene was used, crushed up to a particle size between 80 mesh and 100 mesh. For the first layer polyethylene have a melt index of 4.0 g/10 minutes and a density of 0.938 g/cm³ with a foaming additive.

After chemical treatment, the object surface is heated to between 180 and 300° C. and once it has a uniform temperature, the first layer of plastic powder is applied in order to obtain a thin uniform layer over the entire exposed surface. The thickness is determined by the time that the surface is exposed to the sprayed material.

Immediately after the first layer, a second layer of plastic material is applied, with no additional heat to the object, until the surface is fully covered.

When the temperature of the surface of the object has been reduced to 120° C., it is heated again to 180-280° C. in order to achieve a smooth surface. Subsequently, it is allowed the cooling of the surface to room temperature.

### EXAMPLE 2

The surface of an aluminium sheet is subjected to conditioning or treatment with an acid solution until the sheet surface has been attacked uniform.

For the covering phases of the process of the present invention, it has been used polyethylene crushed or ground to a particle size passing through 80 to 100 mesh, even smaller.

The primary coating consists of polyethylene with a melt index of 4.0 g/10 minutes and a density of 0.938 g/cm³ with an additive added to produce a foaming action.

The second layer of the plastic coating consists of a mixture 1:1 of a coloured polyethylene with a melting index of 4.0 g/10 minutes and a density of 0.938 g/cm³, and a natural polyethylene with a melting index of 25 g/10 minutes and a density of 0.917 g/cm³.

After chemical treatment, the treated surface of the aluminium foil is heated from 180° C. to 300° C. After uniformly heated, the first layer of plastic material is applied. This first polyethylene powder mixture layer is applied on the hot surface of the treated aluminium foil until a first thin coating layer is completely and uniform applied.

Immediately after, the second layer of plastic material is applied by placing a thick layer of the second powder mixture on the first layer. The coated foil is then heated for 5 seconds and excess plastic powder is removed from the surface. The coating thickness was controlled by the time they remained on the plastic material and the surface temperature of the aluminium foil.

After that, the aluminium foil with the coating was subjected to an additional heat source (220° to 300° C.) until the plastic surface it was completely melted. After the coating has gelled slightly, then the coated surface is subjected to a heat source that re-melted the plastic surface to a temperature of between 180 and 280° C. to create a smooth surface. The coated sheet is allowed to cool to room temperature.

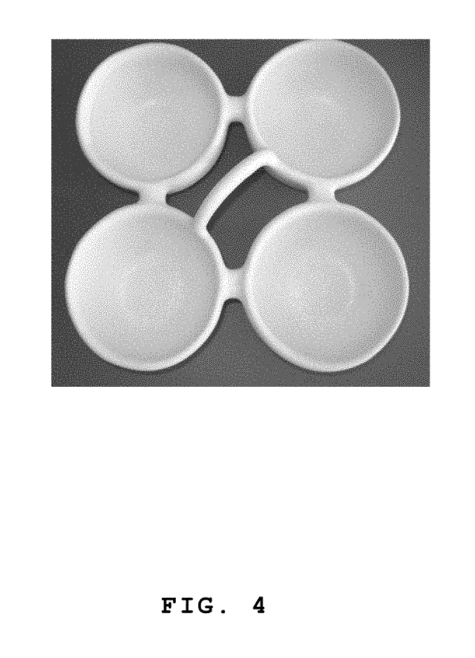

FIG. 4 shows an example of the finish obtained by plastic coating process of the present invention, a treated object with a relatively irregular exposed surface.

Binding Assays

Samples that were tested by tension were produced as described in Example 1 above. These samples are composed of an aluminium substrate moulded with the first and second coating layers of polyethylene. A special heel or test coupon was fabricated by fixing a post to a square piece of aluminium 2.54 cm×2.54 cm. This accessory was placed on top of a piece of aluminium treated by acid attack and the total assembly was coated. This allows the part to be loaded under tension, eliminating the problems of adhesive bonding to polyethylene. The tensile stress exceeded 475 psi.

A second binding test consisted of passing a single edge razor blade between the plastic and the substrate at the interface of the two materials. If the connection is poor, the plastic coating will easily be separated from the substrate. Using this method, tests were conducted on samples in which the substrate surface was chemically. The results produced no failures in any of the degrees of the surface treated with chemicals.

Even though the invention has been described with specific embodiments, it will be understood that it is capable of further modifications and this application is intended to protect any variations, uses, or adaptations of the invention following, in general, the principles of the invention and including such departures from the disclosure herein as occurring within the known and customary practice within the art to which the invention pertains, and as may be applied to the essential features there set forth above, and as follows in the scope of the appended claims.

1. A process for coating of a non-ferrous metallic surface of an articles with a polymeric material, the coating being a polymeric bi-layer where a first coating “adhesive layer” produces a uniform seamless cover with high adherence to the substrate's surface under treatment, and a second coating “working layer”, which provides desirable qualities to the coating, wherein said process comprises the following steps:
a) Treating the non-ferrous metallic surface,
b) Heating the metal object to a temperature above the melting temperature of the polymer selected for the first coating layer (T_{mfc}), but lower than the ignition temperature (T_{ifc}) thereof,
c) Applying a first coating layer of polymer,
i) maintaining the substrate temperature constant,
ii) applying a first coating layer of polymer,
iii) removing excess of the mixture, and
iv) allowing the polymer to uniformly distribute on the surface of the object until this first coating layer has adhered to the surface of the article,
d) Applying a second coating layer of polymer over the first coating layer of the previous step;
e) Heating the ensemble of substrate and bi-layer coating up to a temperature between the melting temperature of the polymer selected for the first coating layer (T_{mfc}), but lower than the ignition temperature (T_{ifc}) thereof, to allow the polymer to flow over the surface and achieve a smooth surface finish, and,
f) Cooling the coated substrate to room temperature; wherein the non-ferrous metallic surface is selected from the group comprising:
aluminium, copper and brass, aluminium alloy and copper, zinc, lead, silver and alloys.

2. The process of claim 1, wherein the non-ferrous substrates is selected from the group comprising aluminium, copper and brass.

3. The process of claim 1, wherein the surface treatment is carried out by immersing the object in an aqueous solution of a chemical agent in water, in a ratio from 1:1 to 1:20.

4. The process of claim 3, wherein the chemical agent is an acid selected from the group including phosphoric, acetic, muriatic, nitric, tannic and/or hydrochloric acids, or a mixture of them.

5. The process of claim 3, wherein the chemical agent is sodium hydroxide.

6. The process of claim 3, wherein the chemical washing is carried out during a time to observe that the metal “pore” is sufficiently open to receive the coating, and after that, the object is washed in water to stop the corrosive effect of the chemical agent.

7. The process of claim 1, wherein the first coating comprises a blend of polymer powder and a conventional foaming agent.

8. The process of claim 7, wherein the polymer of the first coating is polyethylene powder.

9. The process of claim 8, wherein the polyethylene powder has a melt index of 0.5 to 50 g/10 minutes and a density of 0.910 and 0.965 g/cm³.

10. The process of claim 1, wherein the second coating is a simple polymer such as polyethylene, polypropylene, nylon or a mixture of different compatible polymers, such as polyethylene and polypropylene, or polyethylene and nylon.

11. The process of claim 1, wherein the second coating is a mixture of polyethylene with different melting indexes and densities in order to produce a specific superficial appearance.

12. The process of claim 1, wherein the polymers used for the first coating and the second coating, have a particle size less than or equal to 20 mesh.

13. The process of claim 1, wherein the polymers used for the first coating and the second coating, have a particle size between 20 and 400 mesh.

14. The process of claim 1, wherein the polymers used for the first coating and the second coating, have a particle size between 80 to 100 mesh.
